(19) United States
(12) Patent Application Publication
(10) Pub. No.: US 2007/0143925 A1
(43) Pub. Date: Jun. 28, 2007

(54) Multiple position surgery table foot support

(75) Inventors: Ross Edward Paul, Port Moody (CA); Paul Sabiston, Nort Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(73) Assignee: Surgicool Technologies Inc., Port Moody (CA)

(21) Appl. No.: 11/315,008

(22) Filed: Dec. 23, 2005

(51) Int. Cl. A61G 13/12

(52) U.S. Cl. 5/624; 5/651

(57) ABSTRACT

This invention relates to a novel multiple position surgery table foot support. More particularly, this invention pertains to a multiple position foot support which can be clamped to a surgery table under the sterile drapes. A multiple position surgery table foot support comprising: (a) a frame which includes at least two foot positions; and (b) a mechanism attached to the frame for securing the foot support to a surgery table.

### FIELD OF THE INVENTION

This invention relates to a novel multiple position foot support for a surgery table. More particularly, this invention pertains to a multiple position foot support which can be clamped to a surgery table under the sterile drapes and used to enable the surgeon to position a patient's knee in a plurality of degrees of knee flexion during the surgery.

### BACKGROUND OF THE INVENTION

In performing total knee surgery or minimally invasive knee surgery (MIS), the knee of the patient undergoing the surgery must be placed in multiple knee positions with various degrees of flexion at various times during the surgical procedure. A significant number of prior patents disclosing knee positioning devices for surgery or convalescence, usually including clamps, straps and lateral as well as vertical adjustment mechanisms have issued over the years. Most of these patents function by supporting the underside of the patient's thigh and shin so that one knee is in some sort of triangular configuration.

U.S. Pat. No. 1,067,733, Hassel, discloses a two-position foot rest which can be clamped to a bed. The two foot positions are achieved by rotating the foot rest through 90 degrees.

U.S. Pat. No. 1,516,795, Schwarting, discloses a limb support for operating table comprising an elongated bar with an adjustable knee table, which can be clamped to the side of the operating table.

U.S. Pat. No. 3,020,903, Stevens, discloses a limb supporting attachment for an operating table. The attachment includes a pair of vertical arms which are clamped to the operating table. The vertical arms support a pair of cross bars with adjustable knee supporting rests.

U.S. Pat. No. 3,753,557, Kelley, discloses a device, including a base, which is adapted to be adjustably and removably secured on a horizontally disposed operating table. An upwardly inclined support supports the leg bent at an angle, preferably less than 45° at the knee, with the knee elevated and both the upper and lower legs in a substantially a vertical plane and free from obstruction. This clears visibility and access to the lateral sides of the knee and permits lateral movement of the leg. The support is adjustable as to height and the angle at which the leg can be bent and supported. The leg is supported with the foot elevated to an operating level for foot and ankle surgery.

U.S. Pat. No. 4,692,954, Scott, discloses a leg and foot rest for beds comprising a pair of triangular supports, each having a base member with a channel for slidably engaging a side railing of a bed, an angular support member and a vertical support member. A crossbar interconnects the triangular supports and provides a supporting member on which support bars are secured for supporting a footrest. A leg rest having braces on each end can be attached to the angular support members by engaging projections of the braces within apertures provided in the angular support members.

U.S. Pat. No. 4,910,818, Grabill et al., discloses a leg positioning assembly which includes a pillow adapted to separate the knees of a patient and to maintain the knees in flexion. The pillow is preferably three-lobed, with two of the lobes forming a base portion and the third lobe forming a portion which separates the knees of the patient. A raised portion on each of the lobes forming the base portion is provided to support and flex the legs at the knees. A fastening structure is provided to secure the pillow to a patient support. Other fastening structure can be provided to secure the pillow to the legs of the patient.

U.S. Pat. No. 6,438,777 B1, Bender, discloses a leg supporting device which includes a plurality of frame elements. Ends of the frame elements are hingedly connected to one end of an adjacent frame element to define a closed structure. The length of each frame element is adjustable, and the angle formed between adjacent frame elements is adjustable.

U.S. Pat. No. 6,935,992 B2, Gehrke, discloses a device for support and elevation of the lower extremities of a person. More specifically, the invention is a leg elevator that provides calibrated, adjustable support for the upper leg, the lower leg and the foot. The leg elevator is adjustable to different positions through the use of three independent adjustment mechanisms. The upper leg portion of the leg elevator can be adapted to accommodate people that have upper legs of various lengths. The height of the lower leg portion is also adjustable, and the relative angular position of the upper and lower leg can be varied from a generally flat position, to a substantially bent position. The invention can be used to provide elevation for either leg separately or for both legs simultaneously. The leg elevator is lightweight, easily disinfected, and can be collapsed to a relatively flat position for ease in transport and storage.

U.S. Pat. No. 6,953,443 B2, Hay, discloses a simple tibial distraction device which includes a height-adjustable limb support triangle for positioning a patient's knee during surgery. The triangle includes a slidable support plate for carrying a Steinman pin, as well as a foot support strap to apply traction to the patient's lower leg and/or ankle.

GB 1 376 386, Hinrichs G S, discloses a knee support which is located at a level above an end of a table. A foot holder is located substantially at the level of the knee support and is spaced therefrom so that the foot holder can grip the foot of a patient lying on the table. The knee support supports the hollow of the respective knee of a patient.

GB 2 253 565 A, Rich-Bowles, discloses a limb support which serves as an aid during surgery, during the performance of physiotherapeutic exercises, or as a splint. The support comprises elongate gutter-shaped splint formations which are hinged to one another end-to-end. The support is supported upon a surface in a configuration whereby the two splint formations can support the respective leg segments of a person's leg on opposite sides of the knee joint, thereby facilitating a hip or knee operation. The support can be braced by an adjustable length strap extending between the splint formations. The support may be molded from a thermoplastic polymer, in which case the splint formations are connected by an integral piece providing the hinge. Alternatively, the support may be of stainless steel with the splint formations connected by a stainless steel hinge.

WO 03/077819 A1, Subhash, discloses a leg support which supports a human patient's leg during a medical examination or a surgical operation. One embodiment of the invention comprises a first member which supports a patient's lower leg and a second member which supports a patient's upper leg. The support adjustable to suit different patients. Preferably, each of the members is adjustable in length by making the members telescopic. The angle between the members is also adjustable.

Most of these structures are complex, include one or more moving parts, are cumbersome to operate, are expensive and are positioned above the surgical drapes on the surgery table. They must be sterilized before every surgical procedure.

The foregoing examples of the related art and limitations related thereto are intended to be illustrative and not exclusive. Other limitations of the related art will become apparent to those of skill in the art upon a reading of the specification and a study of the drawings.

### SUMMARY OF THE INVENTION

The following embodiments and aspects thereof are described and illustrated in conjunction with systems, tools and methods which are meant to be exemplary and illustrative, not limiting in scope. In various embodiments, one or more of the above-described problems have been reduced or eliminated, while other embodiments are directed to other improvements.

The invention is directed to a multiple position surgery table foot support comprising: (a) a frame which includes thereon at least two foot positions; and (b) a mechanism attached to the frame for securing the foot support to a surgery table.

The frame can include four foot positions which can be spaced from and parallel to one another. The frame can be shaped in the configuration of a rounded “W”. The four foot positions can have padding thereon.

The frame can be in one plane and the securing mechanism can comprise a clamp base secured to a mid-region of the frame, and extending at right angles from the frame. The clamp base can be flat on one side.

The frame can be constructed of metal tubing. The tubing can have flexible plastic foam cylindrical padding at each of the foot position locations on the tubing. The tubing can be stainless steel.

In a second embodiment, the frame can be in the form of an elongated base member, with four parallel perpendicularly extending arms secured thereto and spaced from one another. The four foot positions can have padding thereon.

The securing mechanism can comprise a clamp arm base secured to a mid-region of the frame, and extending at right angles from the foot support, an arm extension extending from the interior of the base, and being adjustable in position, and a clamping foot secured to the free end of the arm extension. The relative position of the arm base and the arm extension can be secured by a clamping screw.

The invention in a specific embodiment is directed to a multiple position surgery table foot support comprising: (a) a planar metal frame in the configuration of a rounded “W”; (b) four padded sleeves on the four arms of the rounded “W”; and (c) an elongated bar secured to a mid-region of the frame and extending at right angles to the plane of the metal frame, the bar being flat on one side.

In addition to the exemplary aspects and embodiments described above, further aspects and embodiments will become apparent by reference to the drawings and by study of the following detailed descriptions.

### DRAWINGS

Exemplary embodiments are illustrated in referenced figures of the drawings. It is intended that the embodiments and figures disclosed herein are to be considered illustrative rather than restrictive.

FIG. 1 illustrates a plan view of the multiple position surgery table foot support.

FIG. 2 illustrates a front view of the multiple position surgery table support.

FIG. 3 illustrates a side elevation view of the multiple position surgery table foot support.

FIG. 4 illustrates a perspective view of the top of a surgery table with the multiple position foot support clamped to the side of a lower portion of the top of the surgery table.

FIG. 5 illustrates a side elevation view of a patient lying on a surgery table top with his foot positioned on one of the foot positions provided by the multiple position foot support.

FIG. 6 illustrates a plan view of a second embodiment of the multiple position surgery table foot support.

FIG. 7 illustrates a plan view of a third embodiment of the multiple position surgery table foot support.

FIG. 8 illustrates a front view of a third embodiment of the multiple position surgery table support.

FIG. 9 illustrates a side elevation view of a third embodiment of the multiple position surgery table foot support.

### DETAILED DESCRIPTION OF THE INVENTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

FIG. 1 illustrates a plan view of the multiple position surgery table foot support. As seen in FIG. 1, the multiple position surgery table foot support 2 comprises a rounded “W” shaped frame 4, preferably made of a metal such as stainless steel tubing. However, plastic or other suitable materials can be used. Hollow cylindrical plastic foam or foam rubber sleeves 6 are positioned on each of the mid-regions of the rounded “W” metal frame 4. Located at the middle of the metal frame 4 is a surgery table clamping base 8. (The clamping base 8 is not visible in FIG. 1.) If the metal frame 4 is formed of hollow stainless tubing or the like, plastic caps (not shown) can be fitted over the two exposed ends of the frame 4.

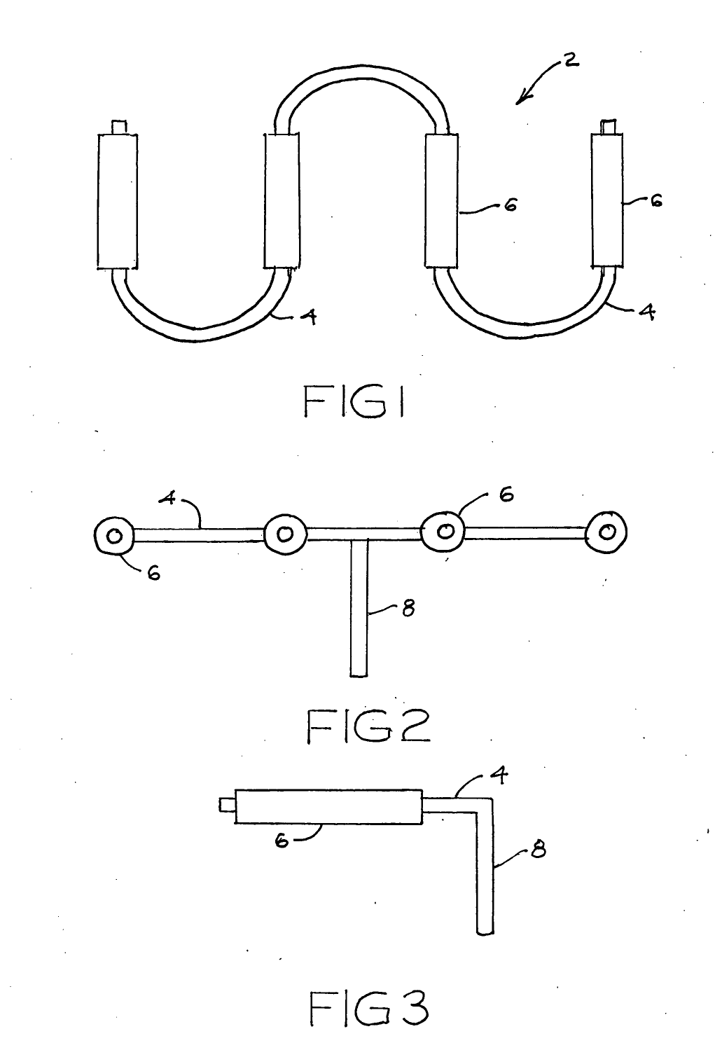

FIG. 2 illustrates a front elevation view of the multiple position surgery table support. As seen in FIG. 2, the frame 4 including four plastic or rubber foam sleeves 6, has attached to its mid-section and extending downwardly, a surgery table clamping base 8. The clamping base 8 is typically a cylindrical bar which is beveled or flat on one side to prevent twisting.

FIG. 3 illustrates a side elevation view of the multiple position surgery table foot support. As seen in FIG. 3, the hollow cylindrical foamed sleeve fits on the frame 4 and the clamping base 8 is connected at right angles to the mid-region of the frame 4 and extends downwardly.

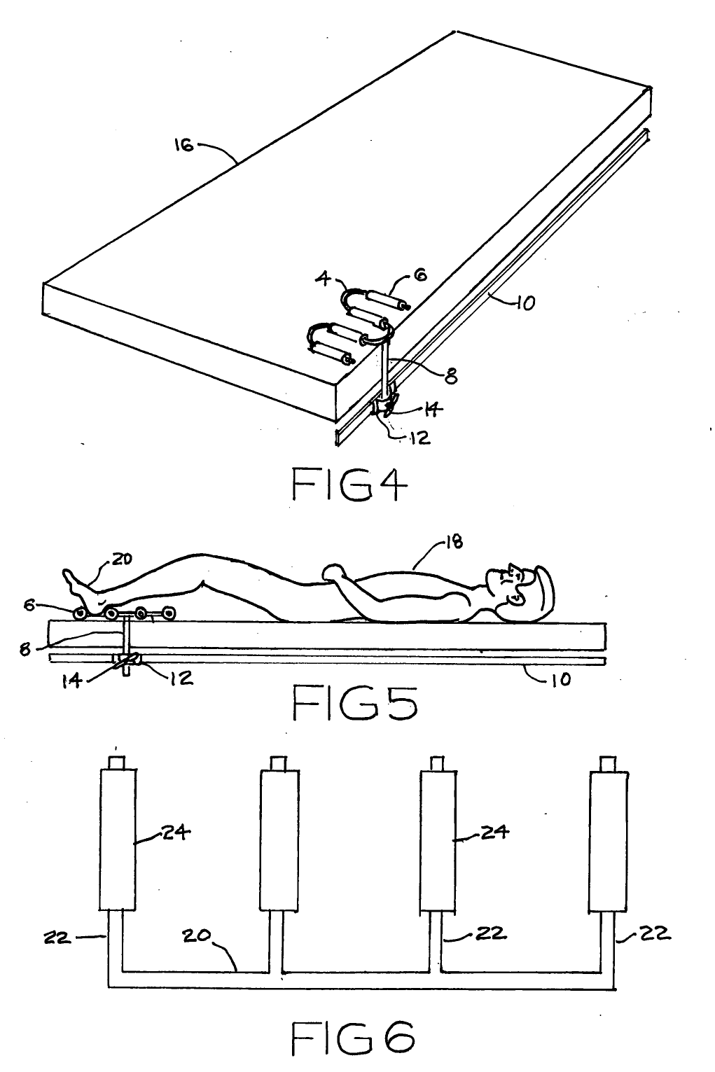

FIG. 4 illustrates a perspective view of a surgery table top with the multiple position foot support clamped to the side of a lower portion of the surgery table top. In FIG. 4, a conventional surgery table top 16 is illustrated without supporting understructure. It will be understood that the surgery table top 16 is supported by legs supporting structure in a conventional manner. FIG. 4 also shows a side rail or clamping bar 10, a movable socket clamp 12 and a clamping screw 14. These components are present on most surgery tables. The multiple position surgery table foot support 2 comprising frame 4, foam sleeves 6 and clamping base 8 are secured to a convenient and suitable location on the side rail bar 10 by the movable clamp 12 and the clamping screw 14. The foot support can of course be unclamped by loosening screw 14 and moved to any other position on the table top 16.

FIG. 5 illustrates a side elevation view of a patient lying on a surgery table top with his foot positioned on one of the foot positions provided by the multiple position foot support. As seen in FIG. 5, the foot 20 of the patient 18 is resting against the left-most foam sleeve 6 of the foot support frame 4. During the surgical procedure, the position of the patient's knee can be elevated or changed in knee flexion by moving the foot 20 of the patient 18 against any of the other three foam sleeves 6 positioned on the metal frame 4. This permits the surgeon to manipulate the elevation and flexion of the patient's knee during the surgical procedure. Since the clamping base 8 is beveled or flat on one side, a secure grip is exerted on the base 8 by the clamp 12 and clamping screw 14. This prevents the base 8 twisting in the clamp 12 when the foot 20 of the patient 18 applies force on the foot support frame 4. The foam sleeve 6 is typically constructed of expanded polyethylene which is sanitary and relatively inexpensive. However, it will be understood that other forms of plastic foam, such as foamed polyvinyl chloride, or other padding materials, such as foam rubber, latex, cotton batting, or the like, can be substituted for the foamed plastic. While not shown in FIG. 5, it is understood that after the foot support 2 is clamped to the appropriate position on the table top 16 using socket clamp 12 on bar 10, a sterilized surgical drape is then spread over the surgery table top 16 and the foot support 2. The patient 18 then lies on the sterilized surgical drape spread over the surgery table 16 and the foot support 2. Because the surgical drape is made of flexible material, it drapes over the foot support and the multiple foot positions on the foot support underneath the drape can be readily accessed by the patient's foot from the top side of the surgical drape.

FIG. 6 illustrates a plan view of a second embodiment of the multiple position surgery table foot support. As seen in FIG. 6, the second embodiment of foot support is constructed of metal components which are arranged and secured together, typically by welding, in right angle configurations. The elongated metal frame base 20 has secured along its length at equal distances from one another four perpendicularly extending arms 22, which in turn each have a hollow plastic foam cylindrical sleeve 24 located thereon. FIG. 6 does not illustrate clamping base 26 but it will be understood that it is located at the middle of the base 20 and is perpendicular to the plane of the frame base 20 and arms 22. It will also be understood that the second embodiment of foot support shown in FIG. 6 is used in the same manner as the foot support shown in FIGS. 1, 2 and 3 for the first embodiment. However, other suitable clamping mechanisms can be used.

While only rounded, “W” and rectangular metal frame constructions have been illustrated in FIGS. 1 and 6, it will be understood that other suitable forms of foot support frames can be designed that fall within the scope of the invention.

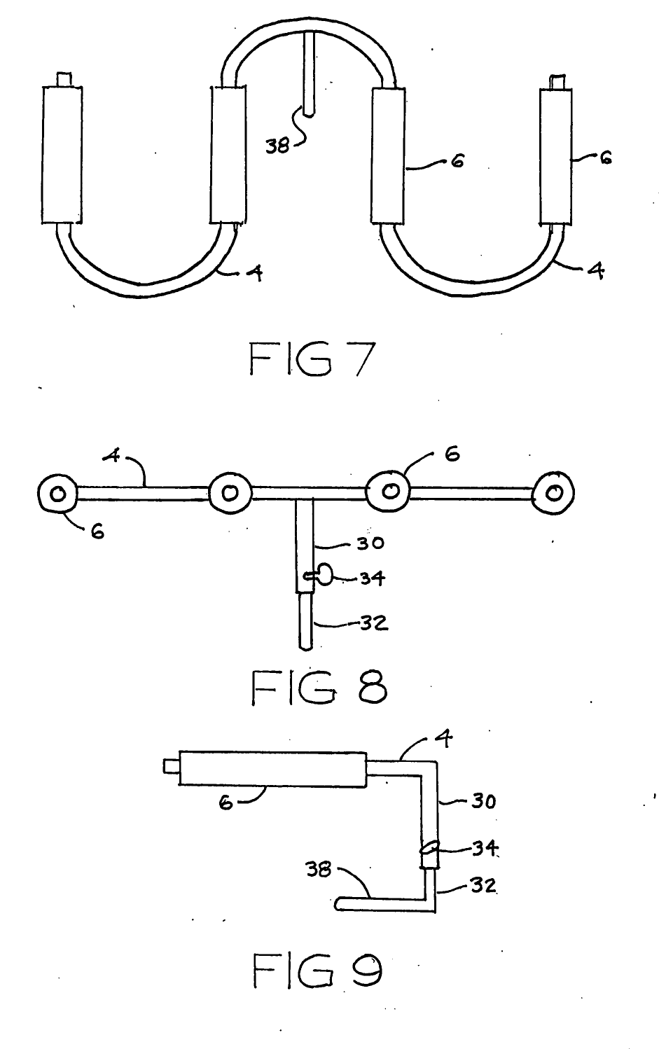

FIG. 7 illustrates a plan view of a third embodiment of the multiple position surgery table foot support. This embodiment of the invention can be used in situations where the surgery table does not have a movable clamp and rail and a clamping device as part of the foot support is required. As seen in FIG. 7, the multiple position surgery table foot support comprises a rounded “W” shaped frame 4, preferably made of a metal such as stainless steel tubing. However, plastic or other suitable materials can be used. Four hollow cylindrical plastic foam or foam rubber sleeves 6 are positioned on each of the mid-regions of the rounded “W” metal frame 4. Visible at the middle of the metal frame 4 is a surgery table clamping foot 38. The clamping foot .38 is connected to a clamp arm base which is not visible in FIG. 1. If the metal frame 4 is formed of hollow stainless tubing or the like, plastic caps (not shown) can be fitted over the two exposed ends of the frame 4.

FIG. 8 illustrates a front elevation view of the third embodiment of the multiple position surgery table support. As seen in FIG. 8, the frame 4 including four plastic foam sleeves 6, has attached to its mid-section and extending downwardly, a surgery table clamp arm base 30, from which extends in a downwardly direction a movable clamp arm extension 32. The clamping foot 38 which is attached at right angles to the base of the extension 32 is not visible in FIG. 8, but is shown in FIG. 7. The clamp arm extension 32 slides in the interior of the clamp arm base 30 and can be adjusted in position and length relative to the base 30 in order to accommodate different thicknesses of surgery table tops. The clamp arm extension 32 is secured in selected position relative to clamp arm base 30 by a position securing screw 34.

FIG. 9 illustrates a side elevation view of the third embodiment of the multiple position surgery table foot support. As seen in FIG. 9, the clamp arm base 30 is attached at right angles to the mid-region of the frame 4 and extends downwardly. The lower end of the clamp arm extension 32 and the clamping foot 38 are also attached to one another in a right angle configuration. The top end of the clamp arm extension 32 slides within the lower hollow end of the clamping arm base 30 and can be secured in any reasonable desired position by the securing screw 34, to accommodate different thicknesses of surgery table tops. It will be understood that while a specific embodiment of clamp construction has been shown, alternative types of clamping mechanisms, such as C-clamps, and the like, can be used.

While a number of exemplary aspects and embodiments have been discussed above, those of skill in the art will recognize certain modifications, permutations, additions and sub-combinations thereof. It is therefore intended that the following appended claims and claims hereafter introduced are interpreted to include all such modifications, permutations, additions and sub-combinations as are within their true spirit and scope.

What is claimed is:

1. A multiple position surgery table foot support comprising:
(a) a frame which includes thereon at least two foot positions; and
(b) a mechanism attached to the frame for securing the foot support to a surgery table.

2. A foot support as claimed in claim 1 wherein the frame includes four foot positions which are spaced from and parallel to one another.

3. A foot support as claimed in claim 2 wherein the frame is shaped in the configuration of a rounded “W”.

4. A foot support as claimed in claim 3 wherein the four foot positions have padding thereon.

5. A foot support as claimed in claim 4 wherein the frame is in one plane and the securing mechanism comprises a clamp base secured to a mid-region of the frame, and extending at right angles from the plane of the frame.

6. A foot support as claimed in claim 5 wherein the clamp base is flat on one side.

7. A foot support as claimed in claim 3 wherein the frame is constructed of metal tubing.

8. A foot support as claimed in claim 7 wherein the metal tubing has hollow cylindrical flexible plastic foam sleeves on each of the four foot position locations on the tubing.

9. A foot support as claimed in claim 1 wherein the frame is in the form of an elongated base member, with four parallel perpendicularly extending arms secured thereto and spaced from one another.

10. A foot support as claimed in claim 9 wherein the four parallel arms provide four foot positions which have padding thereon.

11. A foot support as claimed in claim 10 wherein the frame is in one plane and the securing mechanism comprises a clamp base secured to a mid-region of the frame, and extending at right angles from the plane of the frame.

12. A foot support as claimed in claim 11 wherein the clamp base is flat on one side.

13. A foot support as claimed in claim 12 wherein the frame is constructed of metal tubing.

14. A foot support as claimed in claim 13 wherein the padding is four hollow cylindrical flexible plastic foam sleeves which fit on each of the foot position locations on the tubing.

15. A foot support as claimed in claim 1 wherein the securing mechanism comprises a clamp base secured to a mid-region of the frame, and extending at right angles from the frame, an arm extension extending from the interior of the distal end of the base, and being adjustable in position, and a clamping foot secured to the distal end of the arm extension.

16. A foot support as claimed in claim 15 wherein the frame is constructed of metal tubing.

17. A foot support as claimed in claim 16 wherein the tubing has flexible plastic foam padding at each of the foot position locations on the tubing.

18. A foot support as claimed in claim 16 wherein the relative position of the clamp base and the arm extension is secured by a clamping screw.

19. A foot support as claimed in claim 7 wherein the tubing is stainless steel.

20. A multiple position surgery table foot support comprising:
(a) a planar metal frame in the configuration of a rounded “W”;
(b) four padded sleeves on the respective four arms of the rounded “W”; and
(c) a bar flat on one side secured to a mid-region of the frame and extending at right angles to the plane of the metal frame.
